(19) United States
(12) Patent Application Publication
(10) Pub. No.: US 2002/0078019 A1
(43) Pub. Date: Jun. 20, 2002

(54) Method and system for organizing search results into a single page showing two levels of detail

(76) Inventor: Scott S. Lawton, Chelmsford, MA (US)

Correspondence Address: FOLEY, HOAG & ELIOT, LLP, PATENT GROUP, ONE POST OFFICE SQUARE, BOSTON, MA, 02109, US

(21) Appl. No.: 09/969,502

(22) Filed: Oct. 2, 2001

Related U.S. Application Data
(60) Provisional application No. 60/237,252, filed on Oct. 2, 2000.
(60) Provisional application No. 60/238,577, filed on Oct. 6, 2000.
(60) Provisional application No. 60/238,791, filed on Oct. 6, 2000.
(60) Provisional application No. 60/238,587, filed on Oct. 6, 2000.
(60) Provisional application No. 60/238,754, filed on Oct. 6, 2000.
(60) Provisional application No. 60/237,249, filed on Oct. 2, 2000.
(60) Provisional application No. 60/237,254, filed on Oct. 2, 2000.
(60) Provisional application No. 60/237,250, filed on Oct. 2, 2000.
(60) Provisional application No. 60/237,243, filed on Oct. 2, 2000.

(51) Int. Cl. G06F 7/00; G06F 17/21

(52) U.S. Cl. 707/1; 707/526

(57) ABSTRACT

A method and system for organizing search results into a single page containing an overview section showing a summary of every data object and a detail section showing additional information for every data object, whereby users can browse, save, and/or print two views of each of multiple data objects as a single unit.

### REFERENCE TO RELATED APPLICATIONS

This application claims the benefit of and incorporates by reference the following applications:

U.S. Provisional Application Serial No. 60/237,252 filed on Oct. 2, 2001; Method and System of Entering Search Criteria Using Multiple Entry Fields per Data Element, U.S. Serial No. 60/238,577 filed Oct. 6, 2000; Method and System for Combining User-Supplied Sort Information with Secondary Sort Information, U.S. Serial No. 60/238,791 filed Oct. 6, 2000; Method and System for Organizing Information into Visually Distinct Groups Based on User Input, U.S. Serial No. 60/238,587 filed Oct. 6, 2000; Enhanced Method and System for Viewing Any Search Result Without Returning to the Result List, U.S. Serial No. 60/238,754 filed Oct. 6, 2000; Method and System for Pre-Filling Search Criteria into a Form, U.S. Serial No. 60/237,249 filed Oct. 2, 2000; Enhanced Method and System for Storing and Managing Search Criteria, U.S. Serial No. 60/237,254 filed Oct. 2, 2000; Method and System for Modifying Search Criteria Based on Previous Search Date, U.S. Serial No. 60/237,250 filed Oct. 2, 2000; and Enhanced Method and System for Category Selection, U.S. Serial No. 60/237,243 filed Oct. 2, 2000.

### COPYRIGHT NOTICE

The following patent disclosure includes material that is subject to copyright protection. The copyright owner has no objection to the facsimile reproduction of the disclosure by any person as it appears in the records of the U.S. Patent and Trademark Office, but otherwise reserves all rights to the copyright whatsoever.

### FIELD OF THE INVENTION

The invention relates generally to organizing information retrieved from data repositories, and more particularly to a method and system for formatting search results on a single page with an overview section and a detail section, whereby the overview section helps users understand the scope of the search results and the detail section on the same page provides rapid access to the information contents.

### BACKGROUND OF THE INVENTION

As a society, we are increasingly becoming both dependent on and overloaded with information, especially data that is stored in computer databases or full-text collections. As the quantity of information stored in these data repositories increases, the complexity of retrieving, organizing and understanding relevant information also increases. To locate relevant information, users search general collections (e.g., AltaVista, Excite, InfoSeek, Lycos, Yahoo, etc.) as well as specialized sources which may be implemented with back-end databases, such as those dedicated to locating employment opportunities (e.g., CareerBuilder, CareerPath, Headhunter.net, HotJobs, Monster.com, etc.). According to recent studies from technology analysts (e.g., the Jupiter Group and Forrester Research), Internet searching is the most common online activity next to sending/receiving e-mail communications.

Data repositories may take on several forms, including relational databases, hierarchical databases, flat-file databases, full-text collections, one or more documents, etc. As used herein, the term “data element” refers to a database field, a delimited portion of a document, meta information associated with a document, or to an entire document. As used herein, the term “data object” refers to a database record, a document, or some other grouping of associated data elements. As used herein, the term “data unit” refers to the value or contents of a data element. As used herein, the term “page” refers to a document or page on the World Wide Wide or other public or private network, e.g. a continuously scrollable body of information which may or may not include so-called “frames,” (i.e. portions that do not scroll automatically when other portions of the page are scrolled).

Most search engines on the Internet, whether general or specialized, involve three steps (others require more):

(1) a search form: a fill-in form or other means of entering or selecting search criteria;

(2) a result list: a summary list containing a subset of data elements from each data object that meets the search criteria and a link to a detail page with additional info; often containing only one or a few lines per data object; often divided across multiple linked Web pages when the number of matching data objects exceeds a predetermined value; and

(3) a detail page: a page showing all or substantially all of the relevant contents of those portions of the data object that are made available to the user; often as one page per data object but may include details from multiple data objects on a single page; may link to additional information that is related to the displayed information but is considered to be outside the scope of the user's present search.

The most common way that search engines on the Internet present result and detail information is to have a single page for the result list (when the total number of items is less than a predetermined value), and a single page for each data object—as shown in Figure la. In this case, the result list helps users understand the scope of the search result, and presents enough information about each so that users can determine whether they want to view the detail page for any given data object.

Presenting the detail for each data object on its own page is the obvious approach when the data object is itself a Web page. This approach also has benefits for other types of data objects, such as those originating from a database. For example, some Web usability experts believe that “users don't scroll” (Jakob Nielsen's Alertbox for June 1996); putting each data object on its own page minimizes the need for scrolling.

However, splitting data across multiple Web pages has drawbacks. On slower (low-bandwidth) connections, it takes much longer to load a new page than to scroll to a different section of the current page. High-bandwidth connections deliver the page more quickly but only rarely achieve the sub-second response time that is optimum for human-computer interaction. Furthermore, saving or printing multiple data objects requires significant additional effort when each is on its own page.

To address these problems, some Web sites return the detail for multiple data objects on the same page. However, the result list is left as a separate page—as shown in Figure lb. Because these sites divorce the detail from the overview, users are left with the problem expressed by the colloquial expression “can't see the forest for the trees”; that is, once they are browsing the detail, they no longer have ready access to the summary provided by the result list.

Other Web sites combine the result list with details for a single data object, e.g. by displaying the result list in one frame and displaying details for any selected data object in a second frame. This approach helps users see the context (the “forest”) while viewing any single data object (a “tree”), but otherwise suffers from the drawbacks of splitting the detail across multiple Web pages, as outlined above.

Interactive database management software such as FileMaker Pro typically provides the ability to create custom reports with any level of detail, ranging from a summary result list to complete information about each data object. However, this software does not provide a means of showing a summary in one section of a report and detail for each of the same database records in a different section of a report.

In summary, the prior art does not provide a way for a user to have search results organized into a single page showing two levels of detail, forcing users to spend the additional time and energy required to navigate multiple pages to understand the scope and content of retrieved information.

### SUMMARY OF THE INVENTION

In the present invention, a computer with appropriate software organizes a search result into a single page containing an overview section showing a summary of every data object and a detail section showing additional information for every data object.

The present invention overcomes the prior art limitations by processing each data object twice before returning any formatted output.

It is an object of the invention to reduce the time and frustration associated with finding and understanding information, by providing two levels of detail for each of multiple data objects, such that the result can be browsed, saved and printed as a single unit.

Other objects and advantages of the invention will, in part, be obvious, and, in part, be shown from the following description.

### BRIEF DESCRIPTION OF THE DRAWINGS

FIGS. 1a and 1b depict the organization of search results in the prior art: either a result list page plus one detail page per data object, or a result list page plus one detail page for every data object;

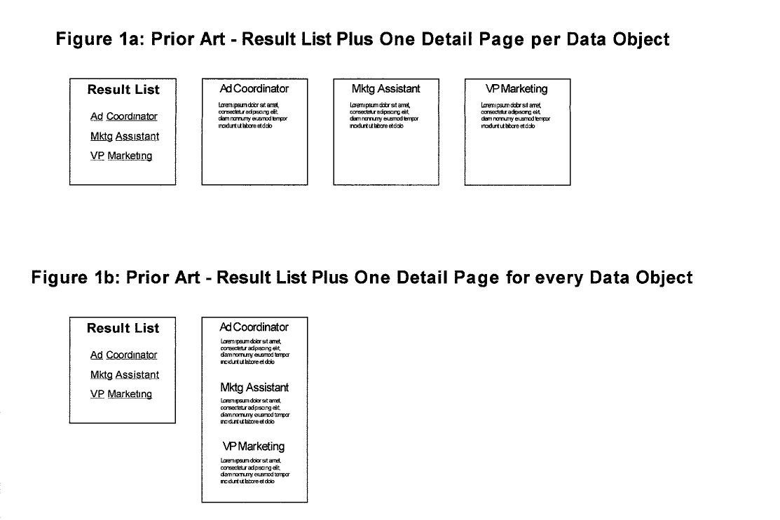

FIG. 2 is a schematic representation depicting the components of one embodiment of the invention;

FIG. 3 depicts the organization of search results according to the invention: result list and detail on the same page;

FIGS. 4a and 4b are flow charts depicting two alternate sequences for creating the overview and detail information;

FIG. 5 is a schematic representation depicting one illustrative embodiment of the invention, wherein the invention is coupled to a network;

FIG. 6 is a schematic representation depicting one illustrative embodiment of the invention, wherein the invention interacts with a single electronic device.

### LIST OF REFERENCE NUMERALS

10 system components

11 overview builder

12 controller

13 detail builder

14 identifier port

16 data port

18 output port

28 server computer

50 system with network

52A-52C IADs

54A-54C Web browsers

56 network

58 HTTP Web server

62 search engine

64 data repository

68 server computer

90 system with single electronic device

### DESCRIPTION OF THE ILLUSTRATIVE EMBODIMENTS

To provide an overall understanding of the invention, certain illustrative embodiments will now be described. However, it will be understood by one of ordinary skill in the art that the methods and systems described herein may be adapted and modified for other suitable applications and that such other additions and modifications will not depart from the spirit and scope of the inventive concept.

To more clearly and concisely describe the subject matter of the invention, the following definitions are intended to provide guidance as to the meaning of specific terms used in the following written description, examples, and appended claims. As used herein, the term or phrase:

“communications network” and “network” include a LAN, a MAN, a WAN, an Intranet, an Extranet, the Internet, a wireless network (e.g., according to the WAP protocol), and the like;

“Information Location Mechanism” (hereinafter “ILM”) includes software, firmware and/or systems capable of searching a data repository to locate information that meets search criteria, such systems including database management systems, search engines supporting full-text search, search engines supporting fielded search, search engines supporting regular expressions and/or other patterns, and/or iterative search engines;

“Information Sorting Mechanism” (hereinafter “ISM”) includes software, firmware and/or systems capable of ordering data objects according to sort criteria, such systems including database management systems, text processing library routines, etc.;

“Internet Access Device” (hereinafter “IAD”) includes personal computer systems (hereinafter “PCs”), computer workstations, desktop computers, laptop computers, hand-held computers, television set-top boxes, wireless access devices such as mobile telephones, cellular telephones, pagers, beepers, and other various hand-held wireless devices, and all other devices that have at least one processor, UD and VDU, and are capable of accessing the Internet and/or other networks;

“processor” includes all components, devices, Integrated Circuits (hereinafter “ICs”), modules, software, subsystems, and/or systems that provide control and/or perform arithmetic and logical operations and/or extract computer instructions and/or decode computer instructions and/or execute computer instructions, such as a Central Processing Unit (hereinafter “CPU”), a microprocessor, a controller, and the like; including any associated memory or other electronic storage of data and/or instructions;

“User-input Device” (hereinafter “UD”) includes keyboards, keypads, mice, trackballs, trackpads, wheels, joysticks, graphics tablets, voice recognition devices, motion sensing devices and other devices for one or more users to enter text, numbers or other data and/or for pointing, clicking, tapping, selecting, dragging and/or other gestures or actions;

“Visual Display Unit” (hereinafter “VDU”) includes CRT screens, monitors, video display terminals, LCD screens, LED screens, digital paper, and all other devices that are capable of displaying analog or digital data;

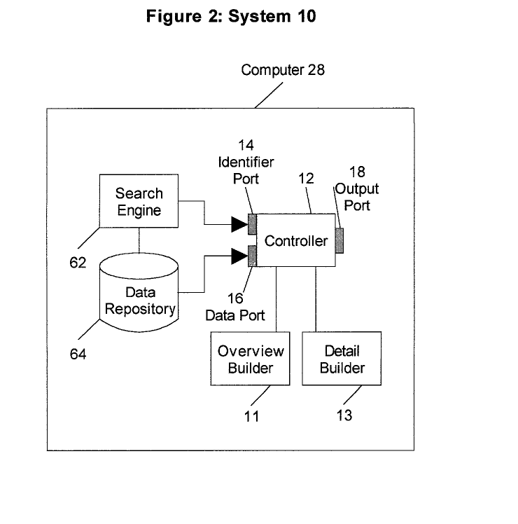

FIG. 2 depicts an illustrative embodiment of one system 10 according to the invention which organizes search results into a single page showing two levels of detail. The system comprises a controller 12 containing an identifier port 14, a data port 16 and an output port 18, an overview builder 11, and a detail builder 13 each coupled to the controller 12. A search engine 62 is coupled to the controller 12 via identifier port 14, and to a data repository 64 which is in turn coupled to the controller 12 via data port 16.

For this illustrative embodiment, the controller 12 with ports 14, 16 and 18, the overview builder 11, the detail builder 13, the search engine 62 and the data repository 64 reside on a single computer 28 which may be a Macintosh G3 running MacOS 8.5. For this illustrative embodiment, the controller 12, the overview builder 11, and the detail builder 13 are coded in the UserTalk language embedded in UserLand Frontier, a commercial scripting and Web development system. For this illustrative embodiment, search engine 62 and data repository 64 are implemented using the FileMaker Pro database management system.

It will be readily apparent to those skilled in the art that the computer 28 could be a different Macintosh computer running a different version of MacOS or a different OS such as Linux, or an Intel or Intel-compatible PC or server running a version of the Microsoft Windows operating system such as Windows 98, Windows NT or Windows 2000, or an Intel or Intel-compatible PC or server running Linux or FreeBSD or other UNIX OS, or a computer from Sun, HP, IBM or other company, running Solaris, HP-UX, AIX or other variation of UNIX or other OS.

It will be readily apparent to those skilled in the art that the functions performed in this embodiment with a single computer 28 could be divided among a plurality of computers from the same or different manufacturers, with each computer running the same or different operating systems.

It will be readily apparent to those skilled in the art that controller 12 and/or overview builder 11 and/or detail builder 13 could be coded in any suitable scripting or programming language such as Perl, JavaScript, Java, VBScript, Visual BASIC, C++, etc. or any suitable Web development system such as Vignette StoryServer, Allaire ColdFusion, SilverStream, etc., and that controller 12, overview builder 11, and detail builder 13 need not be coded in the same language or system.

It will be readily apparent to those skilled in the art that search engine 62 and data repository 64 could be any suitable database management system such as Oracle, Informix, Sybase, SQL Server, Access, mySQL, PostgreSQL, etc. or full-text search engine and associated collection or other index mechanism such as those provided by Verity, UltraSeek, Thunderstone, etc., and/or other software capable of storing and searching data. It will be further apparent that search engine 62 and data repository 64 need not be implemented using the same software nor even reside on the same computer.

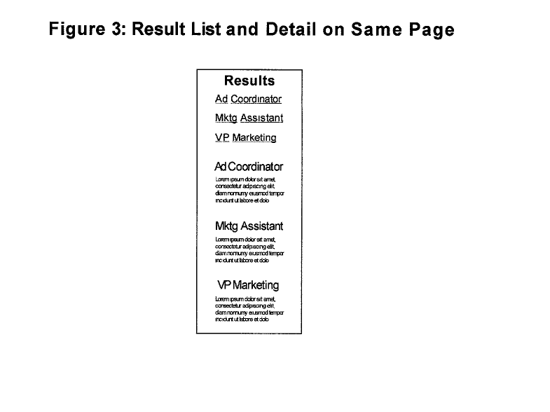

With this illustrative embodiment of the invention, users receive a search result organized as a single page showing two levels of detail, as depicted in FIG. 3. The page shown in FIG. 3 might result from a search for a marketing job at a particular company. In the top section, the three matching jobs are listed: “Ad Coordinator,” “Mktg Assistant,” and “VP Marketing.” At a glance, the user can see how many jobs are available and what type. When implemented on the Web, each job title would be a link (as indicated by the underlines) to the appropriate detailed description below. The bottom section contains detailed information for each job listing, letting the user learn all about the job opening without having to navigate to a different page.

Operation

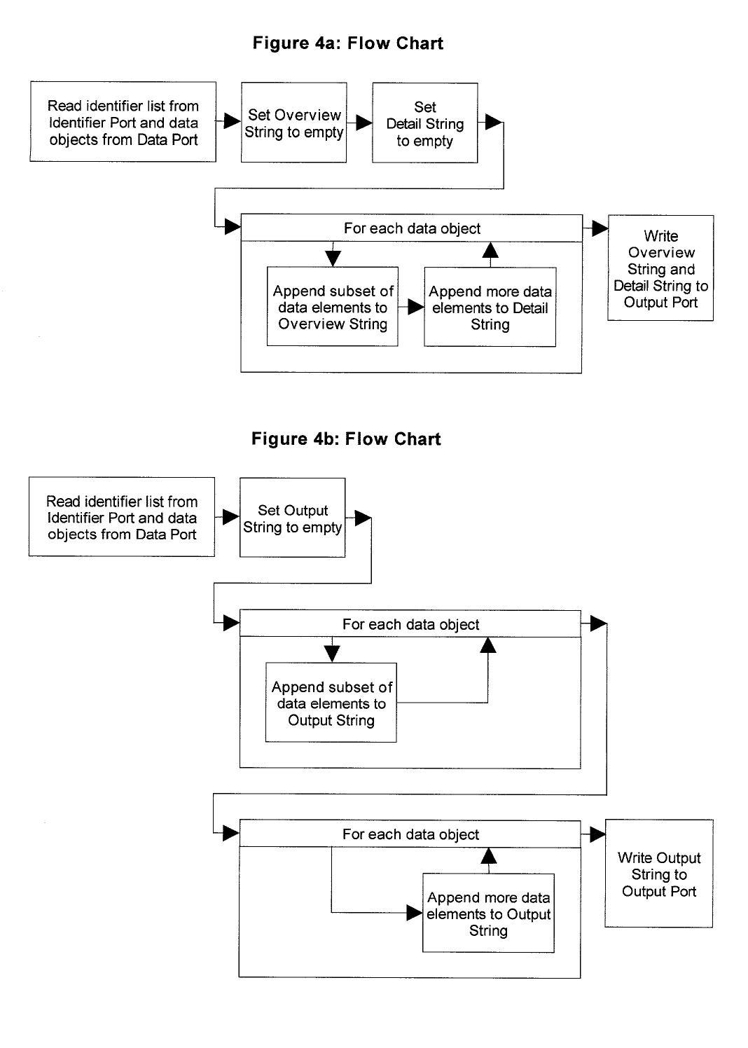

FIG. 4a is a flow chart that depicts one sequence of operation for this illustrative embodiment. Controller 12 receives the identifier list from identifier port 14 and the data objects from data port 16, sets variables Overview String and Detail String to empty, then iterates over each data object identifer in the list of identifiers. For each data object, overview builder 11 appends a subset of data elements to the Overview String and detail builder 13 appends more data elements to the Detail String. After iterating over each data object, controller 12 then sends the Overview String and Detail String to the output port 18 for subsequent display on a single page.

FIG. 4b is a flow chart that depicts an alternate sequence of operation for this illustrative embodiment. Controller 12 receives the identifier list from identifier port 14 and the data objects from data port 16, sets the variable Output String to empty, then iterates over each data object identifer in the list of identifiers. For each data object, overview builder 11 appends a subset of data elements to the Output String. Then, the controller 12 iterates again over each data object identifer in the list of identifiers. For each data object, detail builder 13 appends more data elements to the Output String. After iterating over each data object, controller 12 then sends the Output String to the output port 18 for subsequent display on a single page.

It will be readily apparent to those skilled in the art that the same result could be accomplished with variations on these two cases, such as reading each data object from the data port during iteration instead of at the beginning. It will be further apparent that controller 12 could accept and process information from the identifier port 14 and data port 16 in a variety of formats, each of which may differ from the other.

Alternative Embodiments

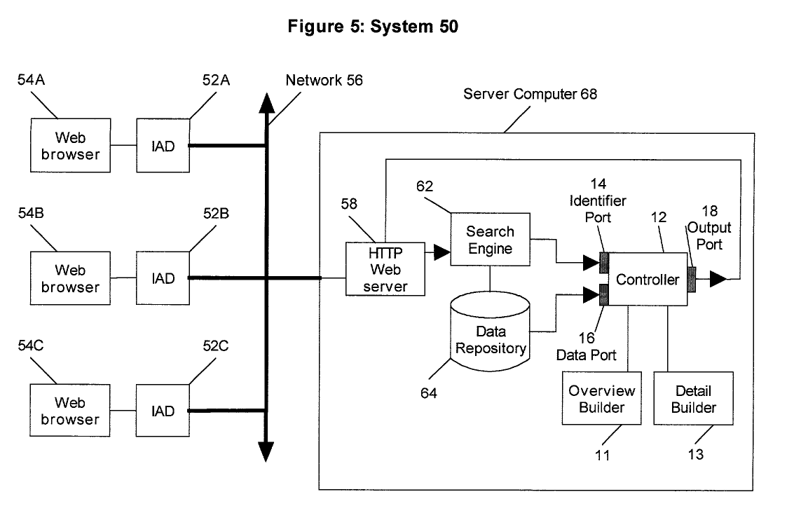

FIG. 5 depicts another illustrative embodiment of one system 50 according to the invention which receives search criteria and displays the results over a network. The system comprises a plurality of IADs 52A-52C, each integrated with or coupled to a client process such as a Web browser 54A-54C and coupled to a network 56, which is in turn coupled to an HTTP Web server 58, which is coupled to search engine 62 to supply search criteria. Search engine 62 is coupled to the controller 12 via identifier port 14, and to a data repository 64 which is in turn coupled to the controller 12 via data port 16. Controller 12 is in turn coupled via output port 18 to the HTTP Web server 58 in order to return formatted data objects to the IADs 52A-52C to display for the users on client processes such as Web browsers 54A-54C.

For this illustrative embodiment, the HTTP Web server 58, search engine 62, data repository 64, controller 12 with ports 14, 16 and 18, overview builder 11, and detail builder 13 reside on a single server computer 68.

It will be readily apparent to those skilled in the art that the functions performed in this embodiment with a single server computer 68 could be divided among a plurality of server computers from the same or different manufacturers, with each computer running the same or different operating systems.

It will be readily apparent to those skilled in the art that the HTTP Web server 58 could be WebStar, WebTen, Microsoft IIS, Apache or other commercial or open source Web server or Web development system, such as UserLand Frontier, which includes a built-in Web server. It will be readily apparent to those skilled in the art that controller 12, overview builder 11, detail builder 13, and other components could interact with HTTP Web server 58 via CGI, plug-in, servlets, Enterprise Java Beans, etc.

Operation:

The user controls one or more UDs to select search criteria via a Web browser 54 running on an IAD 52. The Web browser 54 sends the criteria over the network 56 via the HTTP protocol to the HTTP Web server 58 running on the server computer 68, which forwards the search criteria to search engine 62, which forwards the results to the controller 12 via identifier port 14. Controller 12 invokes overview builder 11 and detail builder 13 to format the data received from the data repository 64 via data port 16 into a single HTML page containing two sections, and sends it to the HTTP Web server 58, which returns the HTML page over the network 56 via the HTTP protocol back to the user's Web browser 54 which displays it on the VDU of IAD 52.

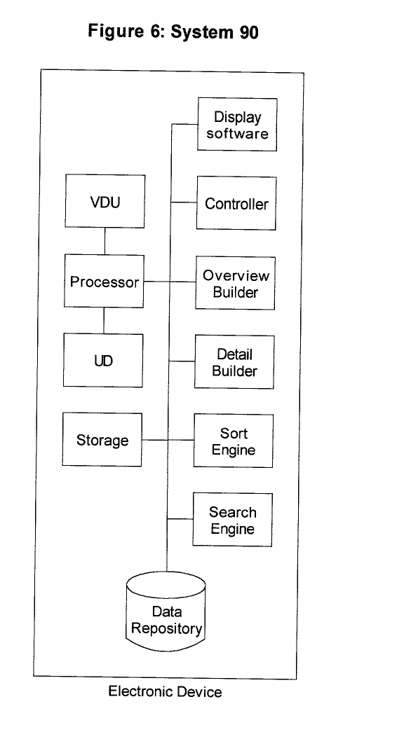

FIG. 6 depicts an illustrative embodiment of one system 90 according to the invention. The system comprises a single electronic device with at least one processor, at least one UD, at least one VDU and some form of storage, with the system 90 running software configured as one or more components to display grouping options, accept user input, perform a search on a local or embedded data repository, sort the results, format the sorted result into a single page showing two levels of detail using controller 12, overview builder 11, and detail builder 13, and display the page to the user on the VDU.

It will be readily apparent to those skilled in the art that, as depicted in FIG. 6, the controller 12 and/or overview builder 11, and detail builder 13 may have direct access to search engine 62 and/or to data repository 64 and/or to a sort engine, reading the data from one or more locations according to the particular embodiment. It will be further apparent from FIG. 6 that search engine 62, data repository 64 and the sort engine have direct access to each other, such that any could access data on behalf of controller 12 according to the particular embodiment.

It will be readily apparent to those skilled in the art that one or more of the depicted individual components could be moved to a different device, situated locally or remotely, to, for example, support a remote data repository or have certain functions performed remotely.

As previously indicated, those skilled in the art will know or be able to ascertain using no more than routine experimentation, many equivalents to the illustrative embodiments and practices described herein. It will also be understood that the methods and systems described herein provide advantages over the prior art by formatting information resulting from a search into a single page showing two levels of detail, to help users understand the scope and content of the information. Accordingly, the scope of the invention should be determined not by the embodiments disclosed herein, but by the following claims, which are to be interpreted as broadly as allowed under the law.

Furthermore, it is to be understood that the terminology used herein is for the purpose of describing particular illustrative embodiments only and is not intended to be limiting. It must be noted that as used herein, including the appended claims, the singular forms “a,” “an,” and “the” include plural referents unless the context clearly dictates otherwise.

What is claimed is:

1. A Two-part Data Formatting System (TDFS) for locating and organizing a plurality of data objects for display on a Visual Display Unit (VDU) via a client process, each data object having a plurality of data elements, each data element having some or no contents, the TDFS comprising:
an Information Location Mechanism (ILM) configured to locate zero or more data objects that meet user-specified search criteria;
a data port configured to receive the plurality of data objects from the ILM;
an overview builder configured to create an overview section having a subset of data elements from each data object;
a detail builder configured to create a detail section having more data elements from each data object than included in the overview section; and
an output port configured to send the overview section and detail section as a single page to the client process and/or to the mechanism that invoked the TDFS;
a controller configured to:
receive the data objects from the ILM via the data port,
invoke the overview builder,
invoke the detail builder, and
send the overview section and detail section to the output port;
whereby the user is presented with a single page showing two levels of detail, to help users understand the scope and content of the information in one place.

2. The TDFS recited in claim 1, further including an identifier port configured to receive from the ILM a list having one or more data element identifiers; and wherein the controller is configured to receive the identifier list via the identifier port and to receive the associated data objects via the data port.

3. The TDFS recited in claim 1 wherein the ILM includes an embedded and/or tightly coupled data repository.

4. The TDFS recited in claim 1, further including a data repository; and wherein the controller is configured to receive the data objects via the data port from the data repository rather than from the ILM.

5. The TDFS recited in claim 1 wherein the overview builder is configured to include a text and/or graphic hypertext link for each data object that links to the detail for that data object.

6. The TDFS recited in claim 1 wherein the detail builder is configured to include a text and/or graphic hypertext link for each data object that links back to the overview for that data object.

7. The TDFS recited in claim 1 wherein the detail builder is configured to include a text and/or graphic hypertext link for each data object that links back to the top of the overview section.

8. The TDFS recited in claim 1 wherein the controller first receives all the data objects then invokes the overview builder and the detail builder.

9. The TDFS recited in claim 1 wherein the controller first receives less than all of the data objects, invokes the overview builder and the detail builder on those received data objects, then repeats these steps until all data objects have been received and processed.

10. The TDFS recited in claim 1 wherein the controller invokes the overview builder to create an overview section for all of the data objects before invoking the detail builder.

11. The TDFS recited in claim 1 wherein the controller invokes the overview builder for less than all of the data objects, then invokes the detail builder on those data objects, then repeats these steps until all data objects have been processed.

12. The TDFS recited in claim 1 wherein the overview section is presented above and/or below the detail section.

13. The TDFS recited in claim 1 wherein the overview section is presented to the left and/or the right of the detail section.

14. The TDFS recited in claim 1 wherein the overview section and the detail section employ a markup language including HTML, XML and/or SGML.

15. The TDFS recited in claim 1 wherein the overview section and the detail section employ script and/or program code.

16. The TDFS recited in claim 1 wherein the ILM and/or the output port is/are coupled to an HTTP Web server, or coupled to a computer-readable media, or configured to communicate via a standard electronic messaging protocol.

17. The TDFS recited in claim 1 wherein the ILM is a database management system, a search engine supporting full-text search, a search engine supporting fielded search, a search engine supporting regular expressions and/or other patterns, and/or an iterative search engine.

18. The TDFS recited in claim 1 wherein each data object is comprised of a database record, a document, or some other grouping of associated data elements.

19. The TDFS recited in claim 1 wherein each data element is comprised of a database field, tagged data including HTML, XML and/or SGML, meta data, and/or a document.

20. The TDFS recited in claim 1 wherein each data element is part of a data object, the data object having at least one data unit of employment information.

21. The TDFS recited in claim 1, further including a format selection port, and wherein the overview builder and/or the detail builder is/are configured to create a specific type of formatted representation based on the selected format.

22. The TDFS recited in claim 1, further including:
a data cache configured to store a copy of zero or more data objects;
a data cache manager to:
check if the indicated data object is already stored in the data cache;
if not, get a copy of the data object via the data port and store it in the data cache;
return a copy of the data object from the data cache to the controller;
and wherein the controller is configured to receive the data objects from the data cache manager and/or from the data port.

23. The TDFS recited in claim 1, further including:
a detail cache configured to store a formatted copy of detail information for zero or more data objects;
a detail cache manager to:
check if the indicated data object is already stored in the detail cache;
if not, invoke the detail builder to create a formatted copy of detail information for the data object and store it in the data cache;
return a formatted copy of detail information from the detail cache to the controller;
and wherein the controller is configured to invoke the detail cache manager rather than the detail builder.

24. A search system comprising:
a search port to receive search criteria;
a client process and VDU to display the formatted data objects;
an TDFS as recited in claim 1 wherein the ILM is coupled to the search port and the output port is coupled to the client process which displays on the VDU.

25. The search system recited in claim 24 wherein the formatted representation from the TDFS employs a markup language including HTML, XML and/or SGML.

26. The search system recited in claim 24 wherein the contents of at least one data element of at least one data object include employment information.

27. The search system recited in claim 24, further including:
a sort port to receive sort criteria;
an Information Sorting Mechanism (ISM) coupled between the ILM and the data port of the TDFS; the ISM being configured to receive the sort criteria in a predetermined syntax, receive a plurality of data objects from the ILM, sort the data objects according to the sort criteria, and forward the sorted data objects to the TDFS via the data port.

28. A two-part data formatting method for locating and organizing a plurality of data objects for display on a Visual Display Unit (VDU) via a client process, each data object having a plurality of data elements, each data element having some or no contents, the method comprising:
locating zero or more data objects that meet user-specified search criteria;
creating an overview section having a subset of data elements from each data object;
creating a detail section having more data elements from each data object than included in the overview section; and
sending the overview section and detail section as a single page to the client process and/or to the mechanism that invoked the method;
whereby the user is presented with a single page showing two levels of detail, to help users understand the scope and content of the information in one place.
